(19) United States
(12) Patent Application Publication
(10) Pub. No.: US 2017/0264162 A1
(43) Pub. Date: Sep. 14, 2017

(54) RESIN MEMBER

(71) Applicants: Nippon Gasket Co., Ltd., Toyota-shi (JP); Toyota Jidosha Kabushiki Kaisha, Toyota-shi (JP)

(72) Inventors: Keisuke NAKAMURA, Toyota-shi (JP); Hiroaki KIYOKAMI, Toyota-shi (JP)

(21) Appl. No.: 15/439,297

(22) Filed: Feb. 22, 2017

(30) Foreign Application Priority Data
Mar. 10, 2016 (JP) 2016-047283

(51) Int. Cl. H02K 7/08; B32B 5/02; B32B 27/06

(52) U.S. Cl. CPC H02K 7/08; B32B 27/06; B32B 5/02; B32B 2262/101

(57) ABSTRACT

An electric generator 1 includes a shaft 3a (metal rotating body), a ball bearing 4 (metal holding body) configured to hold the shaft 3a, and a resin spacer 5 (resin member) used together with these components. A resin part included in the spacer 5 includes reinforcement fibers F pointing in random directions in a plane orthogonal to the axial direction of the shaft 3a. The linear expansion coefficient of the resin part in a direction orthogonal to the axial direction is the same as the linear expansion coefficient of a metal part included in the shaft 3a or the ball bearing 4. Accordingly, the resin member that achieves a dimensional stability can be provided.

### BACKGROUND OF THE INVENTION

Field of the Invention

The present invention relates to a resin member, and particularly relates to a resin member used together with a metal rotating body and a metal bearing.

Description of the Related Art

In a conventionally known configuration (Japanese Utility Model Application Laid-Open Publication 6-43352), a wheel as a metal rotating body is pivotally supported by a ball bearing, and a resin film is formed on the outer periphery of the ball bearing and positioned between the wheel and the ball bearing.

In the configuration in which the resin film is formed on the outer periphery of the bearing as disclosed in Japanese Utility Model Application Laid-Open Publication 6-43352 described above, it is required to provide a resin member between the wheel and the bearing.

However, when such a resin member is used together with a metal rotating body, a gap or backlash is generated and clearance cannot be maintained constant because of their different degrees of deformation upon thermal expansion. Thus, it has been difficult to use a resin member in a part for which a high dimensional stability is required.

To solve such a problem, the present invention provides a resin member that achieves a high dimensional stability.

### SUMMARY OF THE INVENTION

Specifically, a resin member according to the invention of claim 1 is a resin member used together with a metal rotating body, characterized in that a resin part included in the resin member includes reinforcement fibers pointing in random directions in a plane orthogonal to an axial direction of the metal rotating body, and the linear expansion coefficient of the resin part in a direction orthogonal to the axial direction is the same as the linear expansion coefficient of the metal rotating body in the direction orthogonal to the axial direction.

A resin member according to the invention of claim 2 is a resin member pivotally supported by a metal bearing, characterized in that a resin part included in the resin member includes reinforcement fibers pointing in random directions in a plane orthogonal to an axial direction of the metal bearing, and the linear expansion coefficient of the resin part in a direction orthogonal to the axial direction is the same as the linear expansion coefficient of a metal part included in the metal bearing.

According to the above-described inventions, the linear expansion coefficient of the resin part of the resin member in the direction orthogonal to the axial direction is the same as the linear expansion coefficient of the metal part of the metal rotating body or the like. Thus, when the metal rotating body or the like thermally expands, the resin member deforms accordingly, so that no gap nor backlash is generated. As a result, the resin member can be used together with the metal rotating body or the like for which a high dimensional stability is required.

### BRIEF DESCRIPTION OF THE DRAWINGS

FIG. 1 is a cross-sectional view of an electric generator according to a first embodiment;

FIG. 2 is a plan view of the electric generator;

FIG. 3 is a diagram for description of a method of manufacturing a resin member;

FIG. 4 is a cross-sectional view of the electric generator according to a second embodiment;

FIG. 5 is a cross-sectional view of the electric generator according to a third embodiment;

FIG. 6 is a cross-sectional view of the electric generator according to a fourth embodiment; and

FIG. 7 is a cross-sectional view of the electric generator according to a fifth embodiment.

### DETAILED DESCRIPTION OF THE PREFERRED EMBODIMENTS

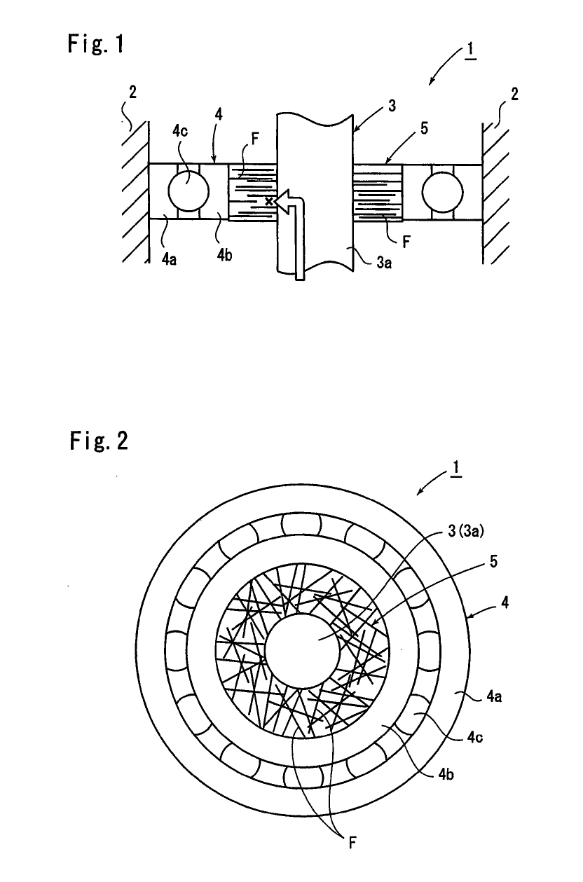

Embodiments of the present invention will be described with reference to the accompanying drawings below. FIGS. 1 and 2 are diagrams of part of the internal structure of an electric generator 1 provided to an automobile engine, illustrating a rotor 3 rotatably provided in a housing 2, a ball bearing 4 fixed to the housing 2 and pivotally supporting the rotor 3, and a ring spacer 5 as a resin member provided between the rotor 3 and the ball bearing 4.

The rotor 3 includes a shaft 3a as a metal rotating body and a core (not illustrated) that is provided to the shaft 3a and around which a coil is wound. The shaft 3a as a metal part is made of iron (S45C).

The ball bearing 4 includes an outer ring 4a fixed to the housing 2, an inner ring 4b positioned inside the outer ring 4a, and a plurality of balls 4c provided between the outer ring 4a and the inner ring 4b. The outer ring 4a and the inner ring 4b as metal parts are made of iron (SUJ2).

In the electric generator 1 having the above-described configuration, when the rotor 3 is rotated by the drive power of the engine, a voltage difference occurs in the coil, which generates current inside the shaft 3a.

If the current flows from the shaft 3a to the housing 2 through the ball bearing 4, the shaft 3a and the ball bearing 4 are damaged due to what is called electric corrosion, potentially causing reduction in lifetime and abnormal vibration.

In the present embodiment, however, the resin spacer 5 is provided between the shaft 3a and the ball bearing 4 to insulate current otherwise flowing from the shaft 3a to the ball bearing 4, thereby preventing the electric corrosion as described above.

The configuration of the electric generator 1 is conventionally known, and thus any further detailed description thereof will be omitted.

The spacer 5 has a ring shape, and rotates integrally with the shaft 3a while being fit by pressing and fixed to the outer peripheral surface of the shaft 3a.

The spacer 5 includes a resin part made of thermosetting resin and reinforcement fibers F. The reinforcement fibers F are made to point in random directions in a plane orthogonal to the axial direction of the spacer 5 by stacking a plurality of sheets described in detail later in the axial direction. The reinforcement fibers F pointing in random directions in the plane orthogonal to the axial direction include those pointing in directions slightly deviated from this orthogonal plane.

Setting the directions of the reinforcement fibers F to be the above-described directions allows the linear expansion coefficient of the resin part in a direction orthogonal to the axial direction of the spacer 5 to be the same as the linear expansion coefficient of the metal part of the shaft 3a. The same linear expansion coefficients mean that the linear expansion coefficients are equivalent to each other, but not that the linear expansion coefficients are identical to each other.

The mix ratio of the thermosetting resin and the reinforcement fibers F is determined based on the linear expansion coefficient of the thermosetting resin and the linear expansion coefficient of the reinforcement fibers F. Phenol as the thermosetting resin needs to be contained in a range of 15% to 35%, aramid fibers as the reinforcement fibers F need to be contained in a range of 10% to 20%, and glass fibers need to be contained in a range of 55% to 65%, so that the linear expansion coefficient of the resin part is the same as the linear expansion coefficient (11.9×10⁻⁶/° C.) of iron (S45C) contained in the metal part of the shaft 3a.

This mix ratio may be changed as appropriate in accordance with the material of the metal part of the shaft 3a, and is applicable to a case in which the metal part is made of metal other than S45C, by changing mixed materials and the ratio thereof.

The resin part contains no conductive material, which provides insulation to prevent current generated in the shaft 3a from flowing into the outer ring 4a of the ball bearing 4.

In this manner, in the spacer 5 according to the present embodiment, the linear expansion coefficient of the resin part in a direction orthogonal to the axial direction of the shaft 3a is the same as the linear expansion coefficient of the shaft 3a. Thus, when the shaft 3a thermally expands upon actuation of the electric generator 1, the spacer 5 deforms accordingly, so that no gap generates between the shaft 3a and the spacer 5 and no change occurs in fitting, thereby maintaining a high dimensional stability required for the shaft 3a.

The spacer 5 according to the present embodiment provides insulation that prevents current from flowing to the ball bearing 4 and the housing 2 from the rotor 3. This eliminates the need to provide a redundant insulation member between the housing 2 and the engine, thereby achieving the insulation with a smaller number of components.

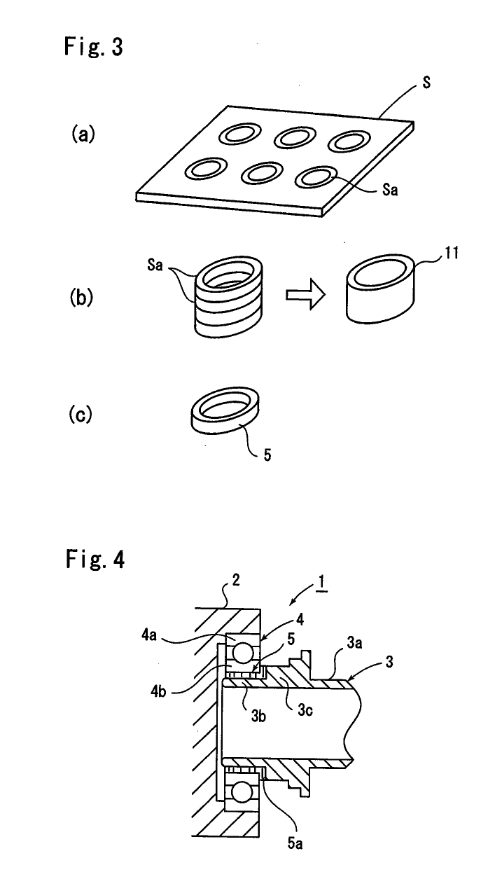

FIG. 3 is a diagram for description of a method of manufacturing the spacer 5. The spacer 5 according to the present embodiment is manufactured by performing heating and compression on a plurality of sheets S stacked in the axial direction, each sheet S being produced through papermaking performed on the thermosetting resin and the reinforcement fibers F being dispersed in a liquid.

In FIG. 3, (a) illustrates a process of manufacturing the sheet S by papermaking and cutting the sheet S into a ring shape.

The sheet S can be obtained by dispersing phenol resin powder as the thermosetting resin, aramid fibers and aramid pulp as the reinforcement fibers F, and glass fibers into water at the above-described mix ratio, subject the mixture to papermaking, and dehydrating the mixture through, for example, a pressurization press machine.

Long fibers each having a length of 3 mm approximately are used as the reinforcement fibers F. When dispersed in water, the long fibers randomly point in the vertical and horizontal directions. When formed into the sheet S, however, the long fibers come down to point substantially in the horizontal direction without becoming short by breaking.

Then, the dehydrated sheet S is transferred into a punching press machine in which a plurality of ring sheets Sa are cut out from a single sheet S. The ring sheets Sa are then further dehydrated by, for example, drying.

In FIG. 3, (b) illustrates a process of shaping an elementary form 11 by stacking a plurality of the ring sheets Sa.

The ring sheets Sa are stacked exactly on top of another in the axial direction, placed into a mold (not illustrated) that restricts the shapes of the inner and outer peripheries of the stack, and compressed in the axial direction, in other words, a stack direction while being heated at a temperature at which the phenol resin is softened.

Then, the phenol resin contained in the sheets Sa become partially softened, and adjacent sheets Sa become bonded to each other. Accordingly, the elementary form 11 in a circular tube shape is obtained. As a result, the reinforcement fibers F further point in the horizontal direction through the compression.

The elementary form 11 has a thickness in the axial direction larger than the thickness of the spacer 5 as a completed product in the axial direction, but has a dimension in a diametrical direction substantially the same as that of the spacer 5 after the shaping. The outer and inner peripheral surfaces of the elementary form 11 have diameters substantially the same as that of the inner peripheral surface of the inner ring 4b and that of the outer peripheral surface of the shaft 3a, respectively.

In FIG. 3, (c) illustrates a process of obtaining the spacer 5 including the resin part by heating and pressurizing the elementary form 11.

Although not illustrated, the present process uses a press device including a recessed lower mold formed in accordance with the shape of the spacer 5, a heating unit configured to heat the lower mold, and an upper mold for shaping the elementary form 11 by pressing between the upper and lower molds.

First, the elementary form 11 is placed in a recess of the lower mold, and then the lower mold is heated by the heating unit to soften the phenol powder contained in the elementary form 11. Then, the upper mold is moved down to obtain the shape of the spacer 5 by pressurizing the elementary form 11, followed by heating again to perform annealing, and finishing work such as burr removal.

Fitting of the shaft 3a by pressing can be performed simultaneously with the shaping of the spacer 5 by inserting the shaft 3a through the inner peripheral surface of the elementary form 11 while the elementary form 11 is being heated and pressurized.

FIG. 4 is a cross-sectional view of the electric generator 1 according to a second embodiment. Similarly to the first embodiment, the electric generator 1 includes the rotor 3 including the shaft 3a as a metal rotating body, the ball bearing 4 as a metal holding body, and the spacer 5 as a resin member used together with these components.

A small-diameter part 3b and a large-diameter part 3c are formed at a leading end part of the shaft 3a. The spacer 5 is mounted on the outer periphery of the small-diameter part 3b. The small-diameter part 3b is pivotally supported by the ball bearing 4.

Similarly to the spacer 5 according to the first embodiment, the spacer 5 according to the present embodiment includes, in the resin part, the reinforcement fibers F pointing in random directions in the plane orthogonal to the axial direction of the shaft 3a. In addition, the linear expansion coefficient of the resin part in the direction orthogonal to the axial direction is the same as the linear expansion coefficients of the metal parts included in the shaft 3a and the inner ring 4b.

A flange part 5a protruding outward is formed at an end part of the spacer 5 and positioned between the inner ring 4b of the ball bearing 4 and the large-diameter part 3c of the shaft 3a.

With this configuration, positioning of the spacer 5 with the ball bearing 4 in the axial direction can be performed through the large-diameter part 3c of the shaft 3a, and in addition, the flange part 5b of the spacer 5 provides insulation to prevent flow of current from the large-diameter part 3c to the ball bearing 4.

The spacer 5 including the flange part 5a can be manufactured by setting, among ring sheets S stacked in the manufacturing of the elementary form 11 described with reference to the above-described (b) of FIG. 3, the outside diameter of a sheet S positioned at the end part to have a larger diameter than that of another sheet S, and using a press device corresponding to the shape of the elementary form 11. Fine dimensional tolerances can be handled through post-processing.

Other components of the second embodiment are the same as those of the first embodiment, and thus detailed description thereof will be omitted.

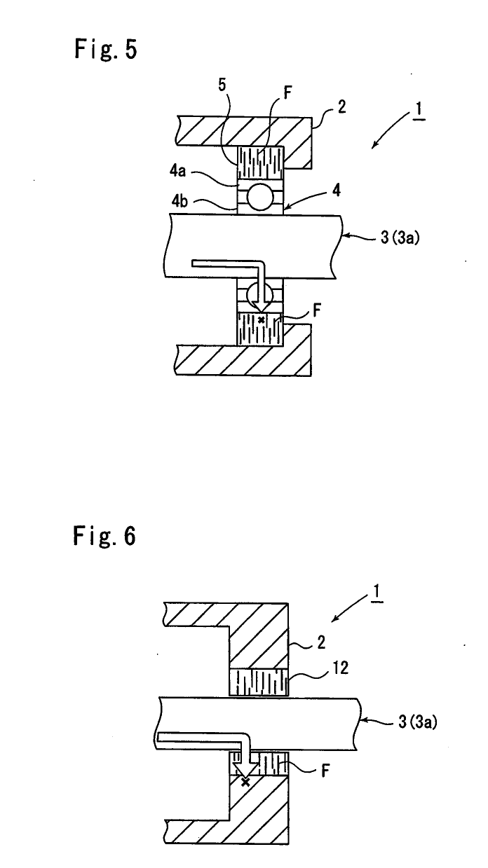

FIG. 5 is a cross-sectional view of the electric generator 1 according to a third embodiment. The electric generator 1 according to the present embodiment includes the rotor 3 including the shaft 3a as a metal rotating body, the ball bearing 4 as a metal holding body, and the spacer 5 as a resin member used together with these components. The ball bearing 4 is fixed to the housing 2 made of iron (S45C) the same as that of the shaft 3a.

In the present embodiment, the shaft 3a and the inner ring 4b of the ball bearing 4 are coupled and fixed to each other, and the spacer 5 is provided between the outer ring 4a of the ball bearing 4 and the housing 2.

Similarly to the spacer 5 according to the first embodiment, the spacer 5 according to the present embodiment includes, in the resin part, the reinforcement fibers F pointing in random directions in the plane orthogonal to the axial direction of the shaft 3a. In addition, the linear expansion coefficient of the resin part in the direction orthogonal to the axial direction is the same as the linear expansion coefficients of the metal parts included in the shaft 3a and the housing 2.

Thus, when the shaft 3a and the outer ring 4a are heated and thermally expanded due to, for example, rotation of the rotor 3, the spacer 5 deforms accordingly, so that no gap is generated between the outer ring 4a and the spacer 5 and no change occurs in fitting.

In addition, the spacer 5 according to the present embodiment provides insulation to prevent flow of current generated inside the rotor 3 from the ball bearing 4 to the housing 2.

FIG. 6 is a cross-sectional view of the electric generator 1 according to a fourth embodiment, illustrating the electric generator 1 including the rotor 3 including the shaft 3a as a metal rotating body, the housing 2 as a metal holding body, and a bush 12 as a resin member used together with these components.

In the present embodiment, the shaft 3a is pivotally supported by the housing 2 through the bush 12 so that the shaft 3a slides on the inner peripheral surface of the bush 12.

Similarly to the spacer 5 according to the first embodiment, the bush 12 according to the present embodiment includes, in the resin part, the reinforcement fibers F pointing in random directions in the plane orthogonal to the axial direction of the shaft 3a. In addition, the linear expansion coefficient of the resin part in the direction orthogonal to the axial direction is the same as the linear expansion coefficient of the metal part included in the shaft 3a or the housing 2.

When the shaft 3a and the housing 2 are made of materials having different linear expansion coefficients, the linear expansion coefficient of the resin part in the direction orthogonal to the axial direction may be set in accordance with the linear expansion coefficient of one of the members for which a higher dimensional stability is required.

Specifically, when a high dimensional stability is required for clearance between the outer peripheral surface of the shaft 3a and the inner peripheral surface of the bush 12, the linear expansion coefficient of the spacer 5 may be set in accordance with the linear expansion coefficient of the shaft 3a. When a high dimensional stability is required between the housing 2 and the bush 12, the linear expansion coefficient of the spacer 5 may be set in accordance with the linear expansion coefficient of the housing 2.

The resin part of the bush 12 according to the present embodiment provides insulation to prevent flow of current generated in the rotor 3 to the housing 2.

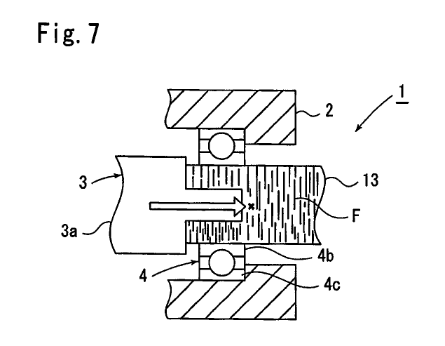

FIG. 7 is a cross-sectional view of the electric generator 1 according to a fifth embodiment. The electric generator 1 includes the rotor 3 including the shaft 3a, and the ball bearing 4 as a metal bearing. A cylindrical cap 13 as a resin member is provided at a leading end of the shaft 3a.

The cap 13 is coupled and fixed to the leading end part of the shaft 3a, and serves as part of the shaft 3a. When the cap 13 is fitted by pressing and fixed to the inner ring 4b of the ball bearing 4, the rotor 3 is pivotally supported by the ball bearing 4.

Similarly to the spacer 5 according to the first embodiment, the cap 13 according to the present embodiment includes, in the resin part, the reinforcement fibers F pointing in random directions in the plane orthogonal to the axial direction of the shaft 3a. In addition, the linear expansion coefficient of the resin part in the direction orthogonal to the axial direction is the same as the linear expansion coefficient of the metal part included in the inner ring 4b.

Thus, when the inner ring 4b is thermally expanded due to, for example, rotation of the rotor 3, the cap 13 deforms accordingly, so that no gap is generated between the outer ring 4a and the spacer 5 and no change occurs in fitting.

In addition, the resin part of the cap 13 according to the present embodiment provides insulation to prevent flow of current generated in the rotor 3 from the shaft 3a to the ball bearing 4.

In place of the configuration in which the cap 13 as a resin member is mounted at the leading end of the metal shaft 3a in the fifth embodiment, the entire shaft 3a may be made of resin and pivotally supported by the ball bearing 4.

In addition, in place of the configuration of the fifth embodiment, the ball bearing 4 may be replaced with a bush as a metal bearing so that the cap 13 rotates while sliding relative to the bush.

In this case, too, clearance between the shaft and the bush can be maintained constant by setting the linear expansion coefficient of the resin part of the shaft in the direction orthogonal to the axial direction to be the same as the linear expansion coefficient of a metal part included in the bush.

In each of the embodiments, the electric generator 1 includes a resin member made of an insulating material to prevent leakage of current generated inside the rotor 3. When used in a device that does not require prevention of the leakage of the current, however, the resin member may contain a conductive material.

Reference Signs List

| | | | |
|---|---|---|---|
| 2 | housing | 3 | rotor |
| 3a | shaft | 4 | ball bearing |
| 5 | spacer | 12 | bush |
| 13 | cap | F | reinforcement fibers |

1. A resin member used together with a metal rotor and a metal holding body configured to hold the metal rotor, characterized in that a resin part included in the resin member includes reinforcement fibers pointing in random directions in a plane orthogonal to an axial direction of the metal rotating body, and a linear expansion coefficient of the resin part in a direction orthogonal to the axial direction is the same as a linear expansion coefficient of a metal part included in the metal rotating body or the metal holding body.

2. A resin member pivotally supported by a metal bearing, characterized in that a resin part included in the resin member includes reinforcement fibers pointing in random directions in a plane orthogonal to an axial direction of the metal bearing, and a linear expansion coefficient of the resin part in a direction orthogonal to the axial direction is the same as a linear expansion coefficient of a metal part included in the metal bearing.

3. The resin member according to claim 1, characterized in that
the resin part includes thermosetting resin and the reinforcement fibers, and
a mix ratio of the thermosetting resin and the reinforcement fibers is set to be the same as a linear expansion coefficient of the metal part based on a linear expansion coefficient of the thermosetting resin and a linear expansion coefficient of the reinforcement fibers.

4. The resin member according to claim 3, characterized in that the resin part contains 15% to 35% of phenol as the thermosetting resin, 10% to 20% of aramid fibers as the reinforcement fibers, and 55% to 65% of glass fibers.

5. The resin member according to claim 1, characterized in that the resin part contains no conductive material and provides insulation.

6. The resin member according to claim 1, characterized in that the resin part is formed by stacking sheets in an axial direction, each sheet being produced through papermaking performed on the thermosetting resin and the reinforcement fibers being dispersed in a liquid.
